(19) United States
(12) Patent Application Publication
(10) Pub. No.: US 2020/0094242 A1
(43) Pub. Date: Mar. 26, 2020

(54) ION EXCHANGE MEMBRANE, ION EXCHANGE MEMBRANE LAMINATE PROVIDED WITH SAME, AND WATER TREATMENT DEVICE

(71) Applicant: Panasonic Intellectual Property Management Co., Ltd., Osaka (JP)

(72) Inventors: Yoshinao OOE, Kyoto (JP); Shigeru SASABE, Shiga (JP); Tomoko TANI, Osaka (JP); Katsuhiko UNO, Nara (JP)

(21) Appl. No.: 16/467,386

(22) PCT Filed: Dec. 18, 2017
(86) PCT No.: PCT/JP2017/045243

§ 371 Date: Jun. 6, 2019

(30) Foreign Application Priority Data
Apr. 11, 2017 (JP) 2017-077972

(51) Int. Cl. B01J 47/12; B01J 39/19; B01J 41/13; C02F 1/42

(52) U.S. Cl. CPC B01J 47/12; B01J 39/19; C02F 2001/425; C02F 1/42; C02F 2001/422; B01J 41/13

(57) ABSTRACT

An ion exchange membrane according to the present disclosure is provided with: a cation exchange composition body that is composed of cation exchange resin particles and a binder resin; and an anion exchange composition body that is composed of anion exchange resin particles and a binder resin. At least one of the cation exchange composition body and the anion exchange composition body is configured to contain a thermally infusible additive.

### TECHNICAL FIELD

The present disclosure relates to an ion exchange membrane, an ion exchange membrane laminate provided with the same, and a water treatment device.

### BACKGROUND ART

here has been proposed, as water treatment devices of this type, a device that removes impurities in water by adsorbing and removing cations or anions using ion exchange resin particles. The water treatment device described above uses an ion exchange membrane having a cation exchange group disposed on one surface and an anion exchange group disposed on the other surface (for example, see PTL 1).

### CITATION LIST

### Patent Literature

PTL 1: Unexamined Japanese Patent Publication No. 2016-391

### SUMMARY OF THE INVENTION

The electrochemical cell having the ion exchange membrane disclosed in PTL 1 needs to increase a ratio of ion exchange resin particles to a binder in order to enhance ion adsorption performance of the membrane. However, in order to form the membrane to have a strength more than necessary during manufacture, a binder ratio needs to be increased. Therefore, the ratio of the ion exchange resin particles is relatively decreased, which leads to a problem that there is a limitation in enhancing performance for adsorbing a hardness component.

Further, the ion exchange membrane disclosed in PTL 1 has a problem that, if the binder contains only a thermoplastic resin, the membrane is less easily released from a roller of a device during manufacture of the membrane.

The present disclosure is accomplished to solve the abovementioned conventional problem, and an object of the present disclosure is to provide an ion exchange membrane having improved performance for adsorbing a hardness component and improved productivity, an ion exchange membrane laminate provided with the sane, and a water treatment device.

In order to solve the foregoing conventional problem, the ion exchange membrane according to the present disclosure is provided with: a cation exchange composition body that is composed of cation exchange resin particles and a binder resin; and an anion exchange composition body that is composed of anion exchange resin particles and a binder resin. At least one of the cation exchange composition body and the anion exchange composition body is configured to contain a thermally infusible additive.

Thus, without an increase in the ratio of the binder resin, the ratio of the ion exchange resin particles is high, more membrane strength than necessary can be maintained during manufacture, releasability from a roller during processing is excellent, and shedding of the ion exchange resin particles can be reduced. Accordingly, the ion exchange membrane having improved performance for adsorbing a hardness component and improved productivity can be provided.

The present disclosure can provide an ion exchange membrane having improved performance for adsorbing a hardness component and improved productivity, an ion exchange membrane laminate provided with the same, and a water treatment device.

### BRIEF DESCRIPTION OF DRAWINGS

FIG. 1 is a sectional view illustrating a schematic configuration of an electrochemical cell according to a first exemplary embodiment of the present disclosure, as viewed from front.

FIG. 2 is a sectional view of the electrochemical cell illustrated in FIG. 1 along line A-A.

FIG. 3 is a schematic view illustrating one example of an ion exchange membrane in the electrochemical cell.

FIG. 4 is a schematic diagram illustrating a schematic configuration of a water treatment device.

### DESCRIPTION OF EMBODIMENT

An ion exchange membrane according to a first aspect is provided with: a cation exchange composition body that is composed of cation exchange resin particles and a binder resin; and an anion exchange composition body that is composed of anion exchange resin particles and a binder resin. At least one of the cation exchange composition body and the anion exchange composition body is configured to contain a thermally infusible additive.

Thus, without an increase in the ratio of the binder resin, the ratio of the ion exchange resin particles is high, more membrane strength than necessary can be maintained during manufacture, releasability from a roller during processing is excellent, and shedding of the ion exchange resin particles can be reduced. Accordingly, the ion exchange membrane having improved performance for adsorbing a hardness component and improved productivity can be provided.

According to a second aspect, in the ion exchange membrane in the first aspect, the thermally infusible additive is made of a fluororesin.

When being given a shearing force by a roller or the like, the thermally infusible additive made of a fluororesin such as polytetrafluoroethylene (PTFE) or polyvinylidene fluoride (PVDF) spreads in the binder resin in a fibrous form (webby form) to firmly fix the membrane. Therefore, even if the ratio of the binder resin is decreased, a strong membrane having less shedding of ion exchange resin particles can be obtained.

An ion exchange membrane laminate according to a third aspect is provided with: the ion exchange membranes, according to the first or the second aspect, the ion exchange membranes being disposed to face each other; and a spacer member provided between the ion exchange membranes adjacent to each other.

With this configuration, water easily permeates into the ion exchange membranes and can be efficiently brought into contact with the ion exchange resin particles in the ion exchange membranes, whereby a water treatment can be efficiently performed.

A water treatment device according to a fourth aspect includes: an electrode including an anode and a cathode; an electrochemical cell including the ion exchange membrane according to the first aspect or the second aspect; a power supply that supplies electric power to the electrode; a first water flow path connected to the electrochemical cell and communicating with a water intake; a second water flow path branched from the first water flow path and communicating with a discharge port; and a flow path switching device switching such that water from the electrochemical cell flows toward the water intake or toward the discharge port.

Thus, a water treatment device that can sufficiently adsorb a hardness component can be provided.

An exemplary embodiment of the present disclosure will be described below with reference to the drawings. Note that the exemplary embodiment should not be construed as limiting the present disclosure.

### First Exemplary Embodiment

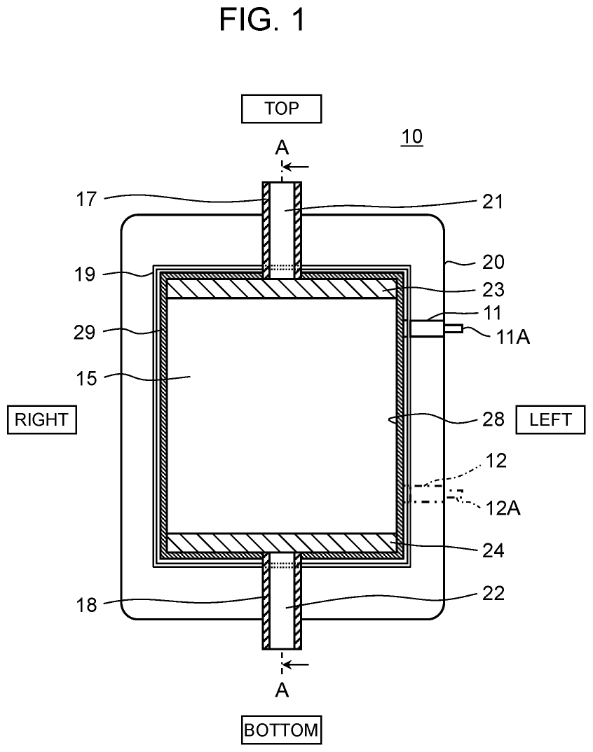

An example of an ion exchange membrane laminate provided with the same according to a first exemplary embodiment and a water treatment device will be described below with reference to FIGS. 1 to 4.

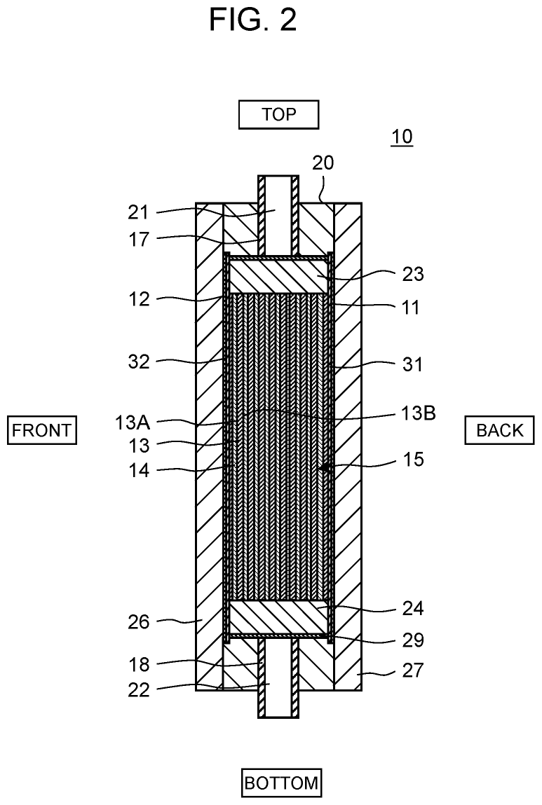

FIG. 1 is a sectional view illustrating a schematic configuration of an electrochemical cell according to the first exemplary embodiment, as viewed from front. FIG. 2 is a sectional view of the electrochemical cell illustrated in FIG. 1 along line A-A. Note that, in FIGS. 1 and 2, the vertical direction, the horizontal direction, and the front-back direction of the electrochemical cell are represented as the vertical direction, the horizontal direction, and the front-back direction in the drawings.

As illustrated in FIGS. 1 and 2, electrochemical cell 10 according to the first exemplary embodiment is provided with anode 11, cathode 12, ion exchange membrane laminate 15, first flow regulating member 24, second flow regulating member 23, casing 20, first outer plate 26, and second outer plate 27. Anode 11 and cathode 12 are disposed to sandwich casing 20 in the front-back direction.

Anode 11 and cathode 12 are formed from titanium, and the surfaces thereof are coated with platinum and iridium oxide. Anode 11 and cathode 12 are formed to cover later-described through-hole 28 in casing 20.

Electrochemical cell 10 in the first exemplary embodiment has a structure in which terminal 11A of anode 11 and terminal 12A of cathode 12 are disposed on the left with terminal 11A being on an upper part and terminal 12A being on a lower part. However, it is not limited thereto. For example, electrochemical cell 10 may have a structure in which terminals 11A and 12A are located on the upper part and on each side in the horizontal direction.

Further, first outer plate 26 and second outer plate 27 are disposed to sandwich anode 11, second sealing member 19, casing 20, and cathode 12 therebetween, and these members are fixed by means of, for example, a screw or the like.

Casing 20 is formed into a plate shape, and provided with through-hole (inner space) 28 in its main surface. An inner peripheral surface (opening of through-hole 28) of casing 20 is formed into a rectangle in the first exemplary embodiment. Further, first sealing member 29 is provided on the inner peripheral surface of casing 20. First sealing member 29 is formed into an annular shape, and formed from, for example, an olefin foam material.

In FIG. 1, first sealing member 29 is provided above and also below ion exchange membrane laminate 15, but it may be provided only on the side of ion exchange membrane laminate 15. Furthermore, second sealing member 19 is disposed at the peripheral edge of casing 20 so as to surround through-hole 28. Note that second sealing member 19 is formed from, for example, silicon rubber.

In addition, a through-hole which vertically extends and communicates with through-hole 28 in the main surface of casing 20 is formed in a lower end surface of casing 20, and this through-hole constitutes inlet port 22. An appropriate pipe is connected to inlet port 22, and this pipe constitutes third water flow path 18. Third water flow path 18 is supplied with treatment water or regeneration water.

Similarly, a through-hole which vertically extends and communicates with through-hole 28 in the main surface of casing 20 is formed in an upper end surface of casing 20, and this through-hole constitutes outlet port 21. An appropriate pipe is connected to outlet port 21, and this pipe constitutes first water flow path 17. Water from which a hardness component or the like is removed or water which has been used for regenerating ion exchange resin particles is discharged into first water flow path 17.

Note that water from which a hardness component or the like is removed by electrochemical cell 10 is referred to as treatment water, and water used for regenerating ion exchange resin particles of ion exchange membrane laminate 15 or the like is referred to as regeneration water.

First flow regulating member 24, ion exchange membrane laminate 15, and second flow regulating member 23 are disposed in through-hole 28 of casing 20 in order from bottom, and these members are fitted to through-hole 28 by first sealing member 29.

First flow regulating member 24 and second flow regulating member 23 are formed into a plate shape in the first exemplary embodiment. Further, first flow regulating member 24 or second flow regulating member 23 is preferably formed from an insulating material from the viewpoint of allowing an electric current to pass through water flowing through ion exchange membrane laminate 15 and preventing the electric current from leaking to the other portions.

In addition, first flow regulating member 24 or second flow regulating member 23 may have greater water flow resistance than ion exchange membrane laminate 15 from the viewpoint of allowing water supplied through third water flow path 18 to uniformly flow through electrochemical cell 10. First flow regulating member 24 or second flow regulating member 23 may be made of, for example, an olefin resin such as polyethylene or polypropylene, and may be formed from a porous sheet. In addition, a hydrophilically treated material may be used.

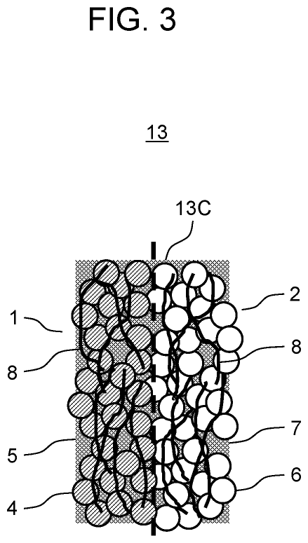

Ion exchange membrane laminate 15 is provided with two or more ion exchange membranes 13 and spacer member 14 having a net shape. Spacer member 14 is disposed between ion exchange membranes 13. Here, ion exchange membrane 13 will be described with reference to FIGS. 2 and 3.

FIG. 3 is a schematic view illustrating one example of the ion exchange membrane in the electrochemical cell according to the first exemplary embodiment.

As illustrated in FIG. 3, ion exchange membrane 13 is provided with cation exchange composition body 1 and anion exchange composition body 2. Cation exchange composition body 1 and anion exchange composition body 2 are formed into a sheet shape.

Cation exchange composition body 1 and first anion exchange composition body 2 are layered such that the main surfaces thereof face (contact) each other. Note that the main surfaces of cation exchange composition body 1 and anion exchange composition body 2 which are in contact with each other may be bonded or may not be bonded to each other.

Cation exchange composition body 1 includes cation exchange resin particles 4 and binder resin 5, and anion exchange composition body 2 includes anion exchange resin particles 6 and binder resin 7.

For example, as cation exchange resin particles 4, a strongly-acidic cation exchange resin particle having an exchange group —SO₃H may be used, or a weakly-acidic cation exchange resin particle having an exchange group —RCOOH may be used. Further, as anion exchange resin particles 6, a strongly-basic anion exchange resin particle having an exchange group —NR₃OH may be used, or a weakly-basic anion exchange resin particle having an exchange group —NR₂ may be used.

A combination of cation exchange resin particles 4 and anion exchange resin particles 6 may be a combination of strongly-acidic cation exchange resin particles and strongly-basic anion exchange resin particles. In such a case, the adsorption rate of the hardness component is increased, whereby water can be softened more.

Further, a combination of cation exchange resin particles 4 and anion exchange resin particles 6 may be a combination of weakly-acidic cation exchange resin particles and weakly-basic anion exchange resin particles. In such a case, an ion-exchange capacity can be increased, whereby a water softening treatment capacity can be increased.

Further, a combination of cation exchange resin particles 4 and anion exchange resin particles 6 may be a combination of strongly-acidic cation exchange resin particles and weakly-basic anion exchange resin particles, and a combination of weakly-acidic cation exchange resin particles and strongly-basic anion exchange resin particles.

In a case where the combination of weakly-acidic cation exchange resin particles and strongly-basic anion exchange resin particles is used, an ion-exchange capacity can be increased, whereby a water softening treatment capacity can be increased. In the case where the combination of weakly-acidic cation exchange resin particles and strongly-basic anion exchange resin particles is used, the resistance of the membrane is decreased, and it is considered that the membrane has catalysis for dissociating water under the strongly-basic state.

For this reason, a potential difference at interface 13C of ion exchange membrane 13 is increased, which can prompt dissociation of water. Therefore, regeneration of ion exchange membrane 13 can be sufficiently executed.

In addition, an average particle diameter of cation exchange resin particles 4 and anion exchange resin particles 6 may be from 1 μm to 150 μm from the viewpoint of decreasing a porous rate.

Binder resin 5 and binder resin 7 may be formed from a thermoplastic resin. Examples of the thermoplastic resin include a polyolefin resin, for example, polyethylene, polypropylene, ethylene-propylene copolymer, ethylene-vinyl acetate copolymer, and ethylene-acrylate copolymer.

It is to be noted that the same kind of thermoplastic resin or different kinds of thermoplastic resins may be used for the thermoplastic resin constituting binder resin 5 and the thermoplastic resin constituting binder resin 7.

Here, in ion exchange membrane 13 according to the first exemplary embodiment of the present disclosure, at least one of cation exchange composition body 1 including cation exchange resin particles 4 and thermoplastic binder resin 5 and anion exchange composition body 2 including anion exchange resin particles 6 and binder resin 7 contains thermally infusible additive 8.

Commonly, in a case where ion exchange resin particles are formed into a membrane using a thermoplastic binder resin or the like, the melted binder resin and the ion exchange resin particles are kneaded so that the ion exchange resin particles are embedded into the binder resin and fixed, whereby the ion exchange resin particles are formed into a membrane.

However, to reliably fix the ion exchange resin particles with the binder resin, the ratio of the binder resin needs to be increased, so that the content of the ion exchange resin particles is relatively decreased. Therefore, the ion-exchange performance tends to decrease. Further, if the amount of the binder resin is increased, the membrane is less easily released from a roller during formation by kneading using a roller device or the like, and thus, the membrane is less easily formed.

In the first exemplary embodiment of the present disclosure, the above problem can be overcome by adding thermally infusible additive 8 made of a fluororesin such as PTFE or PVDF. That is, when being given a shearing force by a roller or the like, thermally infusible additive 8 made of a fluororesin such as PTFE or PVDF spreads in the binder resin in a fibrous form (webby form) to firmly fix the membrane, as fiber-reinforced plastic does. Therefore, even if the ratio of the binder resin is decreased, a strong membrane having less shedding of ion exchange resin particles can be obtained.

In a case where a membrane is formed using only an ion exchange resin and a binder resin, about 50 parts of the binder resin is commonly needed relative to about 50 parts of the ion exchange resin. According to the present exemplary embodiment, a strong membrane can be formed using about 30 parts of the binder resin and about 3 to 8 parts of the additive relative to about 70 parts of the ion exchange resin, and thus, the ion-exchange performance can be improved (note that the part indicates a unit mass).

Furthermore, the additive made of PTFE or PVDF is a material originally used as a release agent, and due to the addition of the additive to the ion exchange resin particles and the binder resin using a roller or the like, releasability from the roller is improved, and membrane-forming property is significantly enhanced. Among PTFE, an acrylic modified material is the optimum, for example.

Specifically, cation exchange composition body 1 may include binder resin 5 in an amount of 10 wt % to 70 wt % from the viewpoint of decreasing the porous rate. The content of binder resin 5 is desirably 20% to 50%. Similarly, anion exchange composition body 2 may include binder resin 7 in an amount of 10 wt % to 70 wt % from the viewpoint of decreasing the porous rate. The content of binder resin 7 is desirably 20% to 50%.

Further, cation exchange composition body 1 and anion exchange composition body 2 may include a conductive material. Examples of the conductive material include carbon particles. Examples of carbon material include graphite, carbon black, and activated carbon. These materials may be used alone or in combination of any two or more thereof. Further, a raw material of the carbon material described above may be in any form such as in powder form, fiber form, granular form, or flake form. Due to the conductive material being included, a potential difference at interface 13C of ion exchange membrane 13 is increased, which can prompt dissociation of water.

Next, spacer member 14 will be described. Spacer member 14 may have insulating property from the viewpoint of preventing an electric current from flowing between adjacent ion exchange membranes 13. In addition, spacer member 14 may be formed by using a material such as polypropylene (PP), polyethylene (PE), or polyester.

In ion exchange membrane laminate 15, ion exchange membrane 13 is disposed such that cation exchange surface 13A faces cathode 12, and anion exchange surface 13B faces anode 11, and a plurality of ion exchange membranes 13 is layered in a direction perpendicular to a vertical direction, as illustrated in FIG. 2. Further, spacer member 14 is disposed between layers of adjacent ion exchange membranes 13.

Moreover, separator 31 is disposed between anode 11 and ion exchange membrane laminate 15, and separator 32 is disposed between cathode 12 and ion exchange membrane laminate 15. Separator 31 and separator 32 are formed from a material having insulating property. Examples of the material having insulating property include polyolefin.

Further, separator 31 and separator 32 have a communicating structure in which front surfaces and back surfaces are in communication with each other. Specifically, separator 31 and separator 32 may be formed from nonwoven fabric.

Subsequently, the operation and effect of electrochemical cell 10 according to the first exemplary embodiment will be described with reference to FIGS. 1 to 3.

During a water softening treatment (water treatment), treatment water is passed from inlet port 22 to outlet port 21. Generally, a voltage is applied with an electrode facing the cation exchange composition body being defined as an anode and an electrode facing the anion exchange composition body being defined as a cathode. It is to be noted, however, that, in a case of use in an area where the hardness of raw water is comparatively low, a significant amount of the hardness component can be removed by passing treatment water without energizing the electrode.

Meanwhile, during regeneration of ion exchange resin particles (during regeneration treatment), regeneration water is passed from inlet port 22 to outlet port 21, and a voltage with a polarity reverse to the polarity upon the water softening treatment is applied. The voltage is applied with the electrode facing the cation exchange composition body being defined as the cathode, and the electrode facing the anion exchange composition body being defined as the anode.

Water supplied to first flow regulating member 24 from inlet port 22 spreads in the horizontal direction while passing through first flow regulating member 24, and is uniformly supplied to ion exchange membrane laminate 15.

During the water softening treatment, the hardness components (cations) such as magnesium components are brought into contact with cation exchange resin particles 4 present within ion exchange membrane 13, and adsorbed and removed. Further, anions such as chloride ions in the treatment water are adsorbed and removed by anion exchange resin particles 6.

Meanwhile, during the regeneration treatment, a potential difference is generated in ion exchange membrane 13, and water dissociates at interface 13C formed by cation exchange resin particles 4 of cation exchange composition body 1 and anion exchange resin particles 6 of anion exchange composition body 2 in ion exchange membrane 13. Then, hydrogen ions are generated on a surface on a side of cathode 12, that is, on a side of cation exchange composition body 1, and hydroxide ions are generated on a surface on a side of anode 11, that is, on a side of anion exchange composition body 2.

Then, the hardness components (cations) adsorbed into cation exchange composition body 1, such as calcium ions or magnesium ions, desorb due to ion exchange with the generated hydrogen ions, whereby cation exchange resin particles 4 in cation exchange composition body 1 are regenerated.

Further, anions adsorbed into anion exchange composition body 2, such as chloride ions, desorb due to ion exchange with the generated hydroxide ions, whereby anion exchange resin particles 6 in anion exchange composition body 2 are regenerated.

Note that the voltage applied between anode 11 and cathode 12 is a DC voltage, and in the present exemplary embodiment, a voltage of 0 V to 300 V is applied during the water softening treatment, and a voltage of 10 V to 500 V is applied during the regeneration. The voltage to be applied may be set, as appropriate, according to the number of ion exchange membranes 13 disposed in casing 20, the hardness of the treatment water, and the like.

The water passing through ion exchange membrane laminate 15 is supplied to second flow regulating member 23. The water supplied to second flow regulating member 23 converges to outlet port 21 while passing through second flow regulating member 23, and is discharged to the outside of electrochemical cell 10 through outlet port 21.

Further, some of gas (for example, chlorine, oxygen, hydrogen) generated in the electrode during the water regeneration treatment enters ion exchange membrane laminate 15, is washed away by water to move upward, and is discharged to the outside of electrochemical cell 10 through outlet port 21.

Here, first flow regulating member 24 and second flow regulating member 23 have a communication structure, and thus, the gas is easily discharged. In addition, insulation at a portion other than the ion exchange membrane laminate facing the electrode is maintained, whereby an occurrence of a short path for current between portions other than the ion exchange membrane laminate can be prevented.

In addition, in electrochemical cell 10 according to the first exemplary embodiment, first sealing member 29 is provided between the inner peripheral surface of casing 20 and second flow regulating member 23, ion exchange membrane laminate 15, and first flow regulating member 24, whereby formation of a gap between these members can be suppressed.

Accordingly, water supplied into casing 20 through inlet port 22 can be suppressed from passing through the gap and being discharged through outlet port 21 without passing through ion exchange membrane laminate 15, whereby the water treatment and the regeneration treatment can be sufficiently carried out.

Moreover, in electrochemical cell 10 according to the first exemplary embodiment, separator 31 is disposed between anode 11 and ion exchange membrane laminate 15, and separator 32 is disposed between cathode 12 and ion exchange membrane laminate 15.

With this configuration, transfer of heat generated when a voltage is applied between anode 11 and cathode 12 to ion exchange membrane laminate 15 is suppressed. Thus, thermal denaturation of ion exchange membrane laminate 15 can be suppressed, whereby the water treatment and the regeneration treatment can be sufficiently carried out.

Moreover, when first flow regulating member 24 and second flow regulating member 23 in electrochemical cell 10 according to the first exemplary embodiment are formed from an insulating material, an electric current does not flow through these members, and thus, charges can be applied only to ion exchange membrane laminate 15. Accordingly, current efficiency can be improved.

Furthermore, in electrochemical cell 10 according to the first exemplary embodiment, net-shaped spacer member 14 is disposed between layers of adjacent ion exchange membranes 13, and thus, water in a space (not illustrated) of spacer member 14 is brought into contact with a second member (not illustrated) when moving upward. The second member is impervious to water, and therefore, the water in contact with the second member easily moves in the front-back direction.

Therefore, the water in the space easily permeates into ion exchange membrane 13, and can be efficiently brought into contact with the ion exchange resin particles in ion exchange membrane 13. Accordingly, electrochemical cell 10 according to the first exemplary embodiment can efficiently carry out the water treatment.

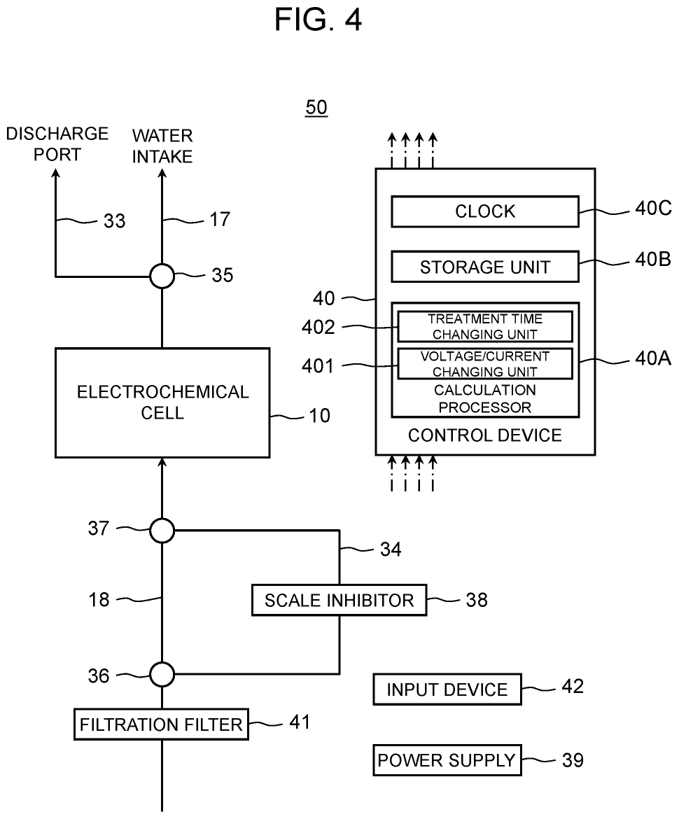

FIG. 4 is a schematic view illustrating a schematic configuration of the water treatment device according to the first exemplary embodiment.

As illustrated in FIG. 4, water treatment device 50 according to the first exemplary embodiment is provided with electrochemical cell 10, power supply 39, first water flow path 17, second water flow path 33, third water flow path 18, first switching valve 35, scale inhibitor 38, input device 42, and control device 40.

As described above, an upstream end of first water flow path 17 is connected to outlet port 21 of electrochemical cell 10, and a downstream end of first water flow path 17 constitutes a water intake. Further, an upstream end of second water flow path 33 is connected to the middle of first water flow path 17, and a downstream end of second water flow path 33 constitutes a discharge port.

Moreover, first switching valve 35 is provided at a connecting point between first water flow path 17 and second water flow path 33 as a flow path switching device. First switching valve 35 is configured to switch such that water passing through first water flow path 17 is supplied to the water intake or supplied to the discharge port through second water flow path 33. A three-way valve or the like can be used as first switching valve 35, for example.

It is to be noted that, although water treatment device 50 according to the first exemplary embodiment uses first switching valve 35 as the flow path switching device, the present disclosure is not limited thereto. For example, two-way valves may be provided at second water flow path 33 and first water flow path 17 at the downstream side of the connecting point with second water flow path 33, respectively, and control device 40 may switch the respective two-way valves between an open state and a closed state so that the two-way valves function as a flow path switching device.

Further, third water flow path 18 is connected to inlet port 22 of electrochemical cell 10. Fourth water flow path 34 is connected to the middle of third water flow path 18, and second switching valve 36 is provided at the portion of third water flow path 18 to which an upstream end of fourth water flow path 34 is connected. Further, third switching valve 37 is provided at a portion of third water flow path 18 to which a downstream end of fourth water flow path 34 is connected.

Second switching valve 36 and third switching valve 37 are configured to switch such that water passing through third water flow path 18 passes through or does not pass through fourth water flow path 34. A three-way valve or the like can be used as second switching valve 36 and third switching valve 37, for example.

In addition, filtration filter 41 is provided at the middle of third water flow path 18, and scale inhibitor 38 is provided at the middle of fourth water flow path 34. Scale inhibitor 38 may be in any form, as long as it can suppress scale deposition or can remove deposited scale.

If polyphosphate salt, for example, is used as scale inhibitor 38, the polyphosphate salt is ablated while water passes through scale inhibitor 38, and thus, deposition of CaCO₃ on the surface of the membrane in electrochemical cell 10, third switching valve 37, or first water flow path 17 can be suppressed.

If citric acid is used for scale inhibitor 38, even if scale is deposited on the interior of electrochemical cell 10, third switching valve 37, or first water flow path 17, such scale can be removed, and adherence of scale can be suppressed.

When a microfilter having a pore diameter of about 0.3 μm to 10 μm is used for filtration filter 41, for example, intrusion of foreign matters into electrochemical cell 10 can be prevented.

Filtration filter 41 can also suppress intrusion of rusty water containing iron salt or the like into the downstream side of filtration filter 41, whereby deposition of iron salt or the like on the surface of the membrane in electrochemical cell 10 can be suppressed, and durability of the membrane can be improved.

Note that, although filtration filter 41 is provided at the upstream side of second switching valve 36 in the first exemplary embodiment, the configuration is not limited thereto. For example, filtration filter 41 may be disposed between second switching valve 36 and third switching valve 37 in third water flow path 18, or at the downstream side of third switching valve 37 in third water flow path 18.

Power supply 39 may be in any form, as long as it can supply electric power to electrochemical cell 10. For example, power supply 39 may be achieved by changing an AC voltage supplied from an AC power supply such as a commercial power supply to a DC voltage by an AC/DC converter, or may be composed of a DC power supply such as a secondary battery.

Input device 42 is configured to set at least any of a voltage value, a current value, and a treatment time. Input device 42 may be configured to directly input a treatment time of the water softening treatment and the regeneration treatment, or may be configured to input an ion concentration of water to be treated. Input device 42 may be composed of a touch panel, a keyboard, a remote controller, or the like.

Control device 40 is configured to control switching valves such as first switching valve 35 and power supply 39. Control device 40 is provided with calculation processor 40A represented by a microprocessor, CPU, or the like, storage unit 40B that is composed of a memory or the like storing a program for executing each of the control operations, and clock 40C having a calendar function.

Control device 40 performs various types of control regarding water treatment device 50 by calculation processor 40A reading a predetermined control program stored in storage unit 40B and executing the read program.

Calculation processor 40A includes voltage/current changing unit 401 that determines a voltage value and/or a current value of power supply 39, and treatment time changing unit 402 that determines the length of the treatment time of the water softening treatment and the length of the treatment time of the regeneration treatment. Note that voltage/current changing unit 401 and treatment time changing unit 402 are achieved by executing the predetermined control program stored in storage unit 40B.

Voltage/current changing unit 401 is configured to change a voltage to be applied to the electrode from power supply 39 during the water treatment and/or the regeneration treatment. Thus, an amount of the removed hardness component can be adjusted, whereby the hardness level in the treatment water can be adjusted as appropriate. Further, an amount of regenerated ion exchange group in the ion exchange composition body can be adjusted, as appropriate, during the regeneration treatment.

Meanwhile, it has been known that ion-exchange capacity per unit time varies to a certain degree depending on a value of a voltage and/or an electric current to be applied to the electrode. On the other hand, the total amount of water which can be softened by electrochemical cell 10 varies according to the ion concentration of water to be treated.

Therefore, treatment time changing unit 402 is configured to be capable of changing the treatment times of the water softening treatment and the regeneration treatment according to the ion concentration of water to be treated. Thus, water treatment device 50 which can flexibly treat water according to use environment can be achieved.

Specifically, treatment time changing unit 402 is configured to change the treatment time of the water softening treatment to be shorter in a case where the treatment water has higher ion concentration as compared to a case where the treatment water has lower ion concentration. Further, treatment time changing unit 402 is configured to change the treatment time of the regeneration treatment to be longer in a case where the treatment water has higher ion concentration as compared to a case where the treatment water has lower ion concentration.

More preferably, the treatment time changing unit is configured to change the treatment time such that a ratio (T1/T2) between treatment time T1 of the water softening treatment and treatment time T2 of the regeneration treatment is increased, as the ion concentration is relatively higher.

Note that, in water treatment device 50 according to the first exemplary embodiment, a sensor for measuring ion content in the treatment water, such as ion concentration or a PH value, is provided to third water flow path 18 which is on the upstream side of electrochemical cell 10, and treatment time changing unit 402 may automatically change the treatment time based on the value measured by the sensor.

It is to be noted that control device 40 is not limited to be composed of a single control device, and control device 40 may be composed of a control device group that controls water treatment device 50 by a plurality of control devices in cooperation with one another. Control device 40 may also be constituted by a microcontroller, or may be constituted by an MPU, programmable logic controller (PLC), a logic circuit, or the like.

The water treatment device thus configured according to the first exemplary embodiment provides an effect similar to that of electrochemical cell 10.

Further, in the water treatment device according to the first exemplary embodiment, scale inhibitor 38 is disposed on the upstream side of electrochemical cell 10, and this can suppress deposition of CaCO₃ generated during the regeneration treatment on ion exchange membrane 13, or the like in electrochemical cell 10, within first water flow path 17, or on first switching valve 35 or the like.

Moreover, in the water treatment device according to the first exemplary embodiment, control device 40 is configured to, when executing the water softening treatment after the regeneration treatment, stop an electric power supply to the electrode for a predetermined time (for example, 1 second to 10 seconds), and then, supply electric power to the electrode from power supply 39 so as to switch the polarity of the electrode and execute the water softening treatment. Note that water is still supplied to electrochemical cell 10 while the electric power supply to the electrode from power supply 39 is stopped.

Thus, calcium ions or the like desorbed during the regeneration treatment pass through second water flow path 33 and can be discharged from the interior of electrochemical cell 10 through the discharge port. Accordingly, when water is softened again after being regenerated, the water is less affected by hard water desorbed during the regeneration treatment, whereby favorable soft water can be obtained through the water intake.

Moreover, in the water treatment device according to the first exemplary embodiment, control device 40 controls the power supply so that electric power to be supplied to the electrode is increased gradually (in a stepwise manner), when executing the regeneration treatment. Thus, upon the start of the regeneration treatment, desorption of a large amount of Ca ions is suppressed, whereby an occurrence of overcurrent is suppressed.

Further, in water treatment device 50 according to the first exemplary embodiment, a flow rate control valve may be further provided to third water flow path 18, and control device 40 may control the flow rate control valve such that the flow rate of water to be supplied to electrochemical cell 10 is decreased during the regeneration treatment, as compared to the flow rate during the water treatment. Thus, an amount of water discharged during the regeneration treatment can be reduced, whereby the regeneration treatment can be efficiently executed.

Moreover, water treatment device 50 according to the first exemplary embodiment may employ a configuration where a flow rate controller is provided to second water flow path 33. The flow rate controller may be formed by adjusting the cross-sectional area of the pipe constituting second water flow path 33 to be smaller than the cross-sectional area of the pipe constituting first water flow path 17. Alternatively, the flow rate controller may be composed of a flow rate control valve.

In such a case, control device 40 may control the flow rate control valve such that the flow rate of water to be supplied to electrochemical cell 10 is decreased during the regeneration treatment, as compared to the flow rate during the water treatment. Thus, an amount of water discharged during the regeneration treatment can be reduced, whereby the regeneration treatment can be efficiently executed.

As described above, according to ion exchange membrane 13, ion exchange membrane laminate 15 provided with the same, and water treatment device 50 according to the present disclosure, a hardness component can be sufficiently adsorbed, and the ion exchange composition body can be efficiently regenerated.

It is obvious to a person skilled in the art that many improvements and other embodiments of the present disclosure are possible from the above description. Therefore, the above description is to be interpreted only as illustration, and it is provided for the purpose of teaching a person skilled in the art the best mode for embodying the present disclosure.

Details of one or both of the structures and functions can substantially be changed without departing from the spirit of the present disclosure. Further, various disclosures can be provided by appropriately combining a plurality of components disclosed in the above embodiment.

### INDUSTRIAL APPLICABILITY

The ion exchange membrane, the ion exchange membrane laminate provided with the same, and the water treatment device according to the present disclosure can sufficiently adsorb a hardness component and efficiently regenerate an ion exchange composition body, whereby they are useful in a field of water treatment.

### REFERENCE MARKS IN THE DRAWINGS

1: cation exchange composition body

2: anion exchange composition body

4: cation exchange resin particle

5: binder resin (included in cation exchange composition body)

6: anion exchange resin particle

7: binder resin (included in anion exchange composition body)

8: additive

10: electrochemical cell

11: anode

12: cathode

13: ion exchange membrane

14: spacer member

15: ion exchange membrane laminate

17: first water flow path

21: outlet port

22: inlet port

35: first switching valve

39: power supply

40: control device

50: water treatment device

1. An ion exchange membrane comprising:
a cation exchange composition body that is composed of cation exchange resin particles and a binder resin; and
an anion exchange composition body that is composed of anion exchange resin particles and a binder resin,
wherein at least one of the cation exchange composition body and the anion exchange composition body contains a thermally infusible additive.

2. The ion exchange membrane according to claim 1, wherein the thermally infusible additive is made of a fluororesin.

3. An ion exchange membrane laminate comprising:
the ion exchange membranes according to claim 1, the ion exchange membranes being disposed to face each other; and
a spacer member provided between the ion exchange membranes adjacent to each other.

4. A water treatment device comprising:
an electrode including an anode and a cathode;
an electrochemical cell including the ion exchange membrane according to claim 1;
a power supply that supplies electric power to the electrode;
a first water flow path connected to the electrochemical cell and communicating with a water intake;
a second water flow path branched from the first water flow path and communicating with a discharge port; and
a flow path switching device switching such that water from the electrochemical cell flows toward the water intake or toward the discharge port.
